(19) United States
(12) Patent Application Publication
(10) Pub. No.: US 2026/0158938 A1
(43) Pub. Date: Jun. 11, 2026

(54) WORK VEHICLE

(71) Applicant: KOMATSU LTD., Tokyo (JP)

(72) Inventors: Go SAKUMA, Tokyo (JP); Yuta HOSHINO, Tokyo (JP)

(21) Appl. No.: 18/717,422

(22) PCT Filed: Dec. 8, 2022
(86) PCT No.: PCT/JP2022/045306

§ 371 Date: Jun. 7, 2024

(30) Foreign Application Priority Data
Dec. 10, 2021 (JP) 2021-200817

(51) Int. Cl. B60L 50/70; B60L 1/00; B60L 7/24; B60L 58/33; F16D 65/78

(52) U.S. Cl. CPC B60L 50/70; B60L 1/00; B60L 7/24; B60L 58/33; F16D 65/78; B60L 2200/40; F16D 2065/784; F16D 2065/787

(57) ABSTRACT

A work vehicle includes an electric motor, a traveling body, and a cooling apparatus. The traveling body is driven by the electric motor. The cooling apparatus is driven by regenerative electric power from the electric motor generated by braking of the traveling body, and cools equipment provided in the work vehicle.

### CROSS-REFERENCE TO RELATED APPLICATIONS

This application is a U.S. National stage application of International Application No. PCT/JP 2022/045306, filed on Dec. 8, 2022. This U.S. National stage application claims priority under 35 U.S.C. § 119(a) to Japanese Patent Application No. 2021-200817, filed in Japan on Dec. 10, 2021, the entire contents of which are hereby incorporated herein by reference.

The present disclosure pertains to a work vehicle.

### BACKGROUND ART

In open-pit mines, hauling vehicles sometimes travel continuously downhill for long periods of time. In such cases, in order to keep the downhill speed constant, brakes are required to be continuously operated while traveling downhill. Japanese Unexamined Patent Application, First Publication No. 2014-054117 discloses an electrically driven dump truck that converts regenerative electric power generated by braking to thermal energy by means of resistors (a retarder grid).

### SUMMARY

In order to provide braking force by converting regenerative electric power to heat by means of a retarder grid, a large retarder grid that can consume the large amounts of energy that are generated downhill is required. A retarder grid that is mounted on a large-scale dump truck is installed on a platform. The platform is a flat plate portion provided above the front wheels of a vehicle body. However, when structures other than a retarder grid are to be installed on the platform, it is preferable to make the retarder grid compact. For example, in order to install a hydrogen tank on the platform of a hauling vehicle driven by a fuel cell, it is preferable to reduce the percentage of the area on the platform occupied by the retarder grid. In order to make the retarder grid more compact, it is required to reduce the electric power consumed by the retarder grid.

An objective of the present disclosure is to provide a work vehicle that can consume regenerative electric power.

According to an embodiment disclosed herein, a work vehicle is provided with an electric motor; a traveling body that is driven by the electric motor; and a cooling apparatus that is driven by regenerative electric power from the electric motor generated by braking of the traveling body, and that cools equipment provided in the work vehicle.

According to the above-mentioned embodiment, the work vehicle can consume regenerative electric power.

### BRIEF DESCRIPTION OF THE DRAWINGS

FIG. 1 is a perspective view schematically illustrating a hauling vehicle according to a first embodiment.

FIG. 2 is a diagram illustrating the structure of a wet-type brake according to the first embodiment.

FIG. 3 is a schematic block diagram illustrating the structure of an electrical system provided in the hauling vehicle according to the first embodiment.

FIG. 4 is a schematic block diagram illustrating the structure of a control apparatus according to the first embodiment.

FIG. 5 is a flow chart indicating retarder control by the control apparatus Substitute Specification according to the first embodiment.

FIG. 6 is a schematic diagram illustrating the structure of the wet-type brake according to a second embodiment.

FIG. 7 is a schematic diagram illustrating the structure of the wet-type brake according to a third embodiment.

FIG. 8 is a schematic block diagram illustrating the structure of an electrical system provided in a hauling vehicle according to the third embodiment.

### DETAILED DESCRIPTION

### First Embodiment

### <<Structure of Hauling Vehicle 10>>

Hereinafter, an embodiment will be explained in detail with reference to the drawings.

The hauling vehicle 10 according to the first embodiment is a rigid-frame dump truck for hauling crushed stone, etc. excavated in a mine, etc. The hauling vehicle 10 is driven by a fuel cell 41 that uses hydrogen gas as fuel. The hauling vehicle 10 is an example of a work vehicle.

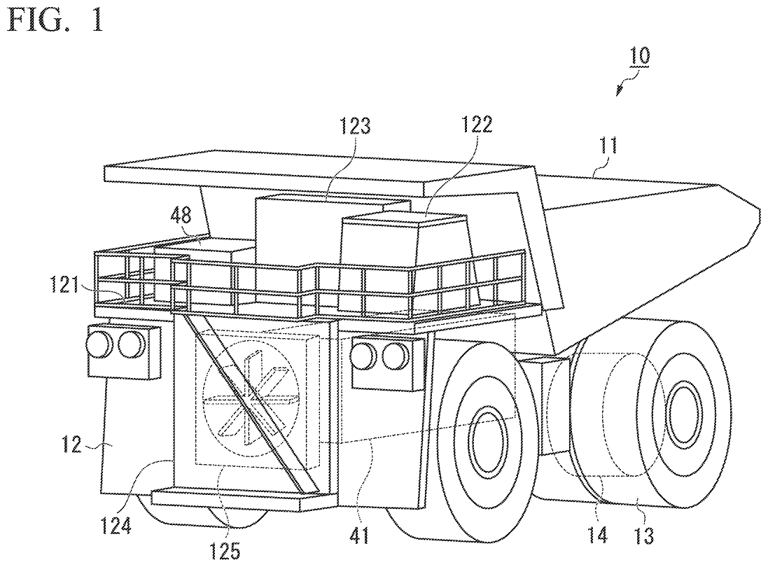

FIG. 1 is a perspective view schematically illustrating the hauling vehicle 10 according to the first embodiment. The hauling vehicle 10 is provided with a dump body 11, a vehicle body 12, and a traveling apparatus 13.

The dump body 11 is an element on which cargo is loaded. At least a portion of the dump body 11 is disposed higher than the vehicle body 12. The dump body 11 performs dumping operations and lowering operations. Due to the dumping operations and the lowering operations, the dump body 11 is adjusted to a dumping orientation and a loading orientation. The dumping orientation refers to an orientation in which the dump body 11 is raised. The loading orientation refers to an orientation in which the dump body 11 is lowered.

The dumping operation refers to an operation for causing the dump body 11 to part from the vehicle body 12 and tilt in a dumping direction. The dumping direction is to the rear of the vehicle body 12. In the embodiment, the dumping operation includes raising the front end of the dump body 11 and tilting the dump body 11 rearward. Due to the dumping operation, the loading surface of the dump body 11 tilts downwards towards the rear.

The lowering operation refers to an operation for bringing the dump body 11 close to the vehicle body 12. In the embodiment, the lowering operation includes lowering the front end of the dump body 11.

When performing earth removal work, the dump body 11 performs a dumping operation to change from the loading orientation to the dumping orientation. When a load is loaded on the dump body 11, the load is discharged rearward from the rear end of the dump body 11 by the dumping operation. When performing loading work, the dump body 11 is adjusted to the loading orientation.

The vehicle body 12 includes a vehicle body frame, which is not illustrated. The vehicle body 12 rotatably supports the dump body 11 by a hinge pin provided on the vehicle body frame. The vehicle body 12 is supported on the travel apparatus 13. A platform 121 is provided on the vehicle body frame above the front wheels of the travel apparatus 13. The platform 121 is a flat plate constituting the upper surface of the vehicle body frame. A driver's cabin 122, a control cabinet 123, and a retarder grid 48 are provided on the platform 121. Additionally, a fuel cell 41 is provided on the vehicle body frame. On the front surface of the vehicle body 12, an opening is provided in a portion in front of the fuel cell 41, and a grill 124 is provided in the opening. A fan 125 for cooling the fuel cell 41 is provided between the grill 124 and the fuel cell 41. The fan 125 cools the fuel cell 41 by drawing outside air inside the vehicle body frame through the grill 124. The fan 125 is an example of a cooling apparatus for the fuel cell 41.

The control cabinet 123 converts electric power. Specifically, the control cabinet 123 implements electric power control between the fuel cell 41, the respective electrical equipment (battery 42, travel motor 47, pump motor 43, etc.), and the retarder grid 48.

The retarder grid 48 is a resistor for absorbing regenerative electric power generated by braking of the travel apparatus 13. The retarder grid 48 converts the regenerative electric power to thermal energy.

The travel apparatus 13 supports the vehicle body 12. The travel apparatus 13 makes the hauling vehicle 10 travel. The travel apparatus 13 makes the hauling vehicle 10 move forward or backward. At least a portion of the travel apparatus 13 is disposed lower than the vehicle body 12. The travel apparatus 13 is provided with a pair of front wheels and a pair of rear wheels. The front wheels are steered wheels and the rear wheels are driving wheels. At least the driving wheels on the travel apparatus 13 are provided with wet-type brakes 14.

### <<Structure of Wet-Type Brake 14>>

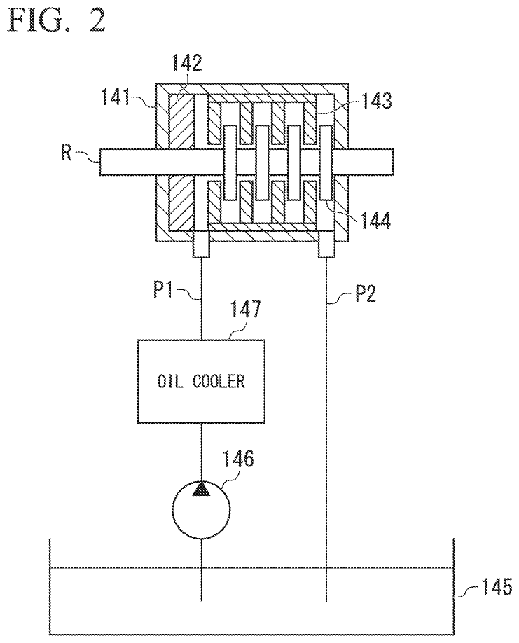

FIG. 2 is a diagram illustrating the structure of a wet-type brake 14 according to the first embodiment.

The wet-type brake 14 brakes the rotation of a rotor R in the travel apparatus 13. The wet-type brake 14 is provided with a brake housing 141, a brake cylinder 142, fixed friction plates 143, rotating friction plates 144, a cooling oil tank 145, a cooling oil pump 146, and an oil cooler 147.

The brake housing 141 is provided so as to cover the rotor R about the axis thereof. The rotor R penetrates through the brake housing 141. The inside of the brake housing 141 is filled with cooling oil and oil seals are provided at the portions connecting with the rotor R.

The fixed fiction plates 143 are provided inside the brake housing 141. The fixed friction plates 143 are held by the brake housing 141 so as to be restricted from rotating about the axis of the rotor R while being able to move in the axial direction of the rotor R. The rotating friction plates 144 are fixed to the rotor R and rotate unitarily with the rotor R. The rotating friction plates 144 are each provided so as to be located between two fixed friction plates 143. The brake cylinder 142 is supported on the brake housing 141 and presses the fixed friction plates 143 in the axial direction of the rotor R. As a result thereof, frictional force is generated by the fixed friction plates 143 and the rotating friction plates 144 strongly contacting each other, thereby braking the rotation of the rotor R. That is, the wet-type brake 14 according to a first embodiment is a disc brake.

A first flow passage P1 and a second flow passage P2 through which cooling oil flows are provided between the cooling oil tank 145 and the brake housing 141. The first flow passage P1 is provided with a cooling oil pump 146 that pumps the cooling oil in the cooling oil tank 145 to the brake housing 141, and an oil cooler 147 that cools the cooling oil. The oil cooler 147 cools the cooling oil by exchanging heat between air and the cooling oil. The cooling oil is supplied from the cooling oil tank 145 to the brake housing 141 through the first flow passage P1, and is returned to the cooling oil tank 145 through the second flow passage P2. The cooling oil supplied to the brake housing 141 recovers heat generated by the friction between the fixed friction plates 143 and the rotating friction plates 144. That is, the cooling oil tank 145, the cooling oil pump 146, and the oil cooler 147 constitute a cooling apparatus for the wet-type brake 14.

The wet-type brake 14 according to another embodiment may be a hydraulic retarder rather than a disc brake. The hydraulic retarder is provided with a brake housing 141 and a propeller fixed to a rotor R inside the brake housing 141. In the hydraulic retarder, the propeller stirs the fluid inside the brake housing 141, thereby braking the rotation of the rotor R by the frictional force generated between the propeller and the fluid. In this case also, the temperature of the fluid inside the brake housing 141 increases due to frictional heat. Thus, as in the first embodiment, the fluid is required to be cooled by the cooling oil pump 146 and the oil cooler 147.

### <<Structure of Electrical System 40>>

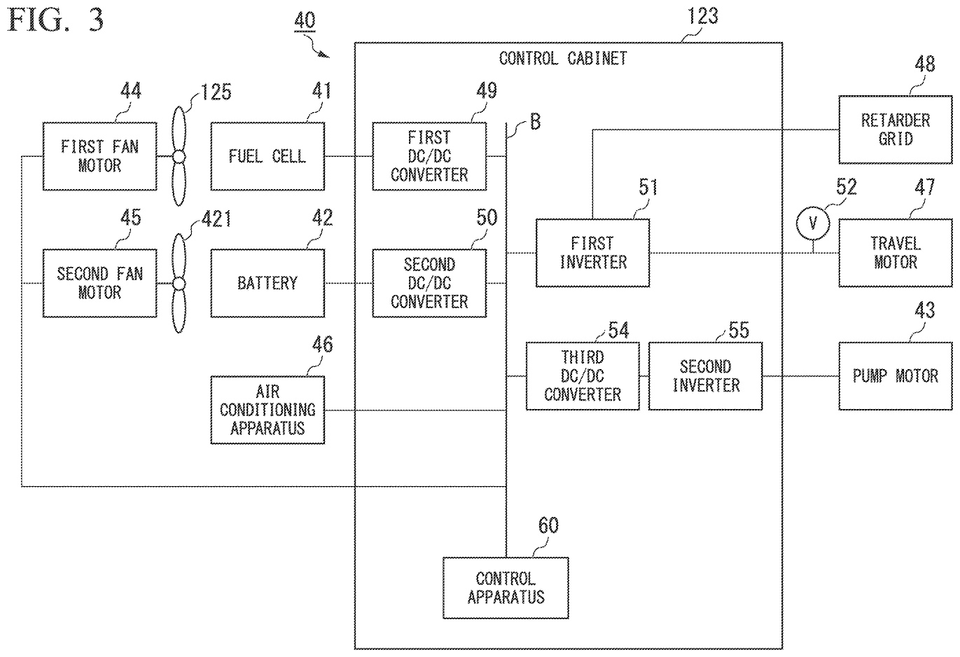

FIG. 3 is a schematic block diagram illustrating the structure of the electrical system 40 provided in the hauling vehicle 10 according to the first embodiment. The electrical system 40 is provided with a fuel cell 41, a battery 42, a pump motor 43, a first fan motor 44, a second fan motor 45, an air conditioning apparatus 46, a travel motor 47, a retarder grid 48, a first DC/DC converter 49, a second DC/DC converter 50, a first inverter 51, a third DC/DC converter 54, a second inverter 55, and a control apparatus 60. The first DC/DC converter 49, the second DC/DC converter 50, the first inverter 51, the third DC/DC converter 54, the second inverter 55, and the control apparatus 60 are provided in a control cabinet 123.

The fuel cell 41 generates electric power by reacting hydrogen gas supplied from a hydrogen tank, not illustrated, with oxygen contained in outside air. The first DC/DC converter 49 supplies DC electric power generated by the fuel cell 41 to a bus line B.

The battery 42 stores the electric power generated in the fuel cell 41. The battery 42 stores regenerative electric power generated in the travel motor 47. The battery 42 outputs the stored electric power. The second DC/DC converter 50 supplies electric power charged in the battery 42 to the bus line B. Additionally, the second DC/DC converter 50 charges the battery 42 by adjusting the voltage of the DC electric power flowing to the bus line B and supplying the voltage to the battery 42. In other words, the second DC/DC converter 50 is an example of a charging apparatus. The battery 42 is provided with a BMS (Battery Management System), not illustrated, that monitors the state of the battery 42. The BMS measures the charge rate of the battery 42 and outputs the measurement data to the control apparatus 60.

The pump motor 43 drives the cooling oil pump 146 illustrated in FIG. 2 by the DC electric power flowing to the bus line B. The pump motor 43 according to the first embodiment is driven at a rotation speed in accordance with a required load, regardless of whether or not there is regenerative electric power. That is, the cooling oil pump 146 is driven regardless of the regenerative electric power.

The first fan motor 44 drives the fan 125 illustrated in FIG. 1 by means of the DC electric power flowing to the bus line B.

The second fan motor 45 drives a fan 421 provided near the battery 42 for cooling the battery 42 by means of the DC electric power flowing to the bus line B. The fan 421 is an example of a cooling apparatus for a battery 42.

The air conditioning apparatus 46 adjusts the temperature inside the driver's cabin 122. Specifically, the air conditioning apparatus 46 is provided with a compressor, a condenser, an expansion valve, and an evaporator. The compressor is electrically driven to compress a refrigerant. The condenser dissipates heat from the refrigerant by exchanging heat between a coolant and high-pressure refrigerant discharged from the compressor. The expansion valve reduces the pressure of the refrigerant that has passed through the condenser. The evaporator evaporates the refrigerant by exchanging heat between low-pressure refrigerant flowing from the expansion valve and air in the driver's cabin 122. As a result thereof, cooled air is supplied to the driver's cabin 122. The air conditioning apparatus 46 is an example of a cooling apparatus for the driver's cabin 122.

The travel motor 47 is a three-phase AC electric motor for driving the travel apparatus 13. The inverter 51 converts the DC electric power flowing to the bus line B to three-phase AC electric power and supplies the electric power to the travel motor 47.

Additionally, the inverter 51 converts regenerative electric power generated in the travel motor 47 by braking the travel apparatus 13 to DC electric power, and supplies the electric power to the bus line B. A voltmeter 52 is provided in the travel motor 47. The voltmeter 52 measures voltages associated with the traveling motor 47. The voltmeter 52 transmits the measurement data to the control apparatus 60.

The control apparatus 60 controls the first DC/DC converter 49, the second DC/DC converter 50, the inverter 51, the first fan motor 44, the second fan motor 45, and the air conditioning apparatus 46 based on measurement data received from the BMS of the battery 42, the voltmeter 52, and ammeters, voltmeters, etc. in other electrical equipment.

<<Structure of control apparatus 60>>

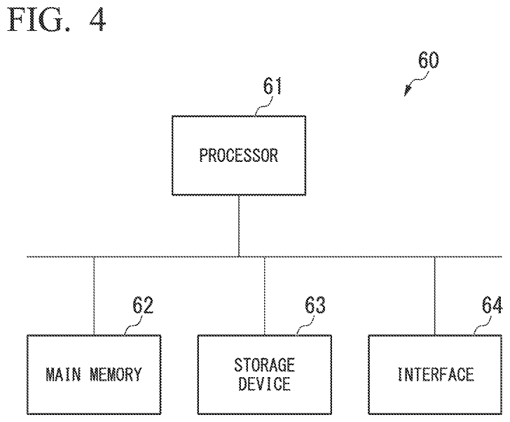

FIG. 4 is a schematic block diagram illustrating the structure of a control apparatus 60 according to a first embodiment.

The control apparatus 60 is a computer provided with a processor 61, a main memory 62, a storage device 63, and an interface 64.

The processor 61 reads out a program from the storage device 63, loads the program in the main memory 62, and executes processes in accordance with the program. Examples of the processor 61 include a CPU (Central Processing Unit), a GPU (Graphic Processing Unit), a microprocessor, etc.

The program may be for realizing just some of the functions provided by the control apparatus 60. For example, the program may provide the functions in combination with another program already stored in the storage device or in combination with another program installed in another apparatus. In another embodiment, the control apparatus 60 may be provided with a custom LSI (Large-Scale Integrated circuit), such as a PLD (Programmable Logic Device), in addition to the above-mentioned structures or instead of the above-mentioned structures. Examples of the PLD include a PAL (Programmable Array Logic), a GAL (Generic Array Logic), a CPLD (Complex Programmable Logic Device), and a FPGA (Field-Programmable Gate Array). In this case, some or all of the functions realized by the processor 61 may be realized by said integrated circuit. Such an integrated circuit is also included as an example of the processor.

Examples of the storage device 63 include a magnetic disc, a magneto-optic disc, an optical disc, a semiconductor memory, etc. The storage device 63 may be internal media directly connected to a bus, or may be external media connected to the control device 60 via an interface 64 or a communication line. Additionally, in the case in which this program is distributed to the control apparatus 60 by a communication line, the control apparatus 60 that has received the distribution may load the program in the main memory 62 and execute the above-mentioned processes. In at least one embodiment, the storage device 63 is a non-transitory, tangible storage medium.

Additionally, the program may be for realizing just some of the afore-mentioned functions. Furthermore, the program may be a so-called difference file (difference program) that realizes the afore-mentioned functions in combination with another program already stored in the storage device 63.

<<Retarder control by control apparatus>>

The hauling vehicle 10 according to the first embodiment starts retarder control when, for example, an operator steps on a brake pedal. When the retarder control is started, the control apparatus 60 in the hauling vehicle 10 makes the travel motor 47 function as a power generator with a load in accordance with the amount by which the brake pedal is stepped, and generates a braking force (electric braking) by consuming the regenerated electric power with the retarder grid 48. If the braking force provided by the retarder grid 48 is insufficient, the control apparatus 60 in the hauling vehicle 10 provides a braking force by activating the wet-type brake 14 (mechanical braking) by exciting the brake cylinder 142. The electric braking and the mechanical braking may be generated simultaneously based on the operator stepping on the brake pedal.

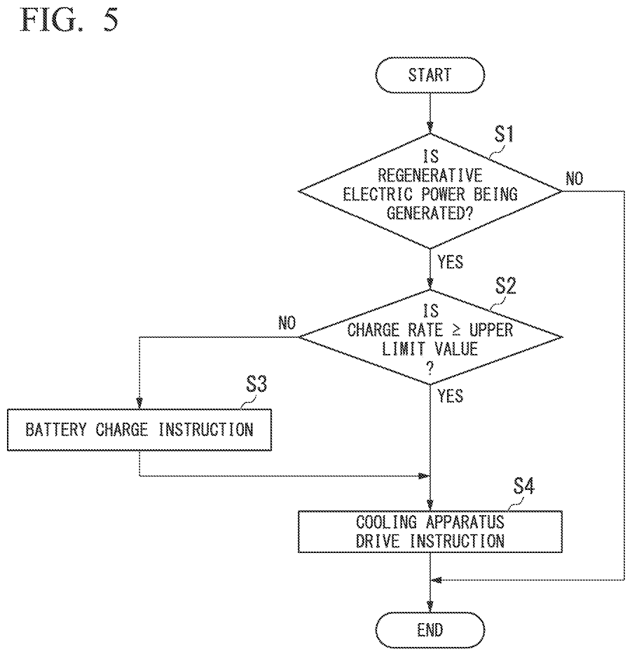

FIG. 5 is a flow chart indicating retarder control by the control apparatus 60 according to the first embodiment. The control apparatus 60 executes the retarder control indicated in FIG. 5 periodically with a fixed period.

First, the control apparatus 60 determines whether or not regenerative electric power is being generated based on the brake pedal being stepped on (step S1). The control apparatus 60 determines whether or not there is regenerative electric power, for example, by a measurement value from a potentiometer provided on the brake pedal. The control apparatus 60 according to another embodiment may determine whether or not there is regenerative electric power by measurement data (the sign of a voltage value) received from the voltmeter 52. In the case in which regenerative electric power is not being generated (step S1: NO), the control apparatus 60 ends the retarder control.

On the other hand, in the case in which regenerative electric power is being generated (step S1: YES), the control apparatus 60 determines whether or not the charge rate of the battery 42 is equal to or higher than an upper limit value based on measurement data received from the BMS of the battery 42 (step S2). In the case in which the charge rate of the battery 42 is lower than the upper limit value (step S2: NO), the control apparatus 60 outputs, to the second DC/DC converter 50, an instruction to charge the battery 42 (step S3). As a result thereof, the control apparatus 60 can make the battery 42 absorb regenerative electric power (regenerative braking), and can reduce the electric power (power generation braking) consumed by the retarder grid 48.

In the case in which an instruction to charge the battery 42 has been output or in the case in which the charge rate of the battery 42 is equal to or higher than the upper limit value (step S2: YES), the control apparatus 60 outputs an instruction to drive the cooling apparatus (step S4). In other words, the control apparatus 60 outputs drive instructions to the first fan motor 44, the second fan motor 45, and the air conditioning apparatus 46. As a result thereof, the first fan motor 44 is driven by the regenerative electric power flowing through the bus line B and the fan 125 is driven. Additionally, the second fan motor 45 is driven by the regenerative electric power flowing to the bus line B and the fan 421 is driven. Additionally, the air conditioning apparatus 46 is operated by the regenerative electric power flowing to the bus line B.
Then, the control apparatus 60 ends the retarder control.

### <<Functions and Effects>>

Thus, the control apparatus 60 in the hauling vehicle 10 according to the first embodiment operates the first fan motor 44, the second fan motor 45, and the air conditioning apparatus 46, i.e., a cooling apparatus, by the regenerative electric power of the travel motor 47 generated by braking the travel apparatus 13. As a result thereof, the hauling vehicle 10 can make the cooling apparatus absorb the regenerative electric power. Additionally, since the operation of the fuel cell 41 causes the temperature to increase, the electric system 40 can prevent temperature increases by means of the cooling apparatus.

As mentioned above, the hauling vehicle 10 according to the first embodiment can reduce the regenerative electric power to be consumed by the retarder grid 48 by operating the cooling apparatus. In the case in which the travel route of the hauling vehicle 10 is known in advance, the size of the retarder grid 48 can be designed based on the braking force of the wet-type brake 14 and the amount of electric power that can be absorbed by the battery 42 and the cooling apparatus. As a result thereof, the retarder grid 48 can be made compact and space for installing other structures can be secured on the platform 121. An example of another structure provided on the platform 121 is a hydrogen tank, etc. filled with hydrogen gas to be supplied to the fuel cell 41.

The first fan motor 44, the second fan motor 45, and the air conditioning apparatus 46 may operate even when regenerative electric power is not being generated. In this case, the control apparatus 60 controls the cooling apparatus so that the electric power consumed by the cooling apparatus when regenerative electric power is being generated becomes greater than the electric power consumed by the cooling apparatus when regenerative electric power is not being generated.

For example, the control apparatus 60 may rotate the first fan motor 44 at a rotation speed in accordance with the temperature of the fuel cell 41 when regenerative electric power is not being generated, or may rotate the first fan motor 44 at a fixed rotation speed when regenerative electric power is not being generated, provided that the control apparatus 60 controls the first fan motor 44 so that the rotation speed of the first fan motor 44 when regenerative electric power is generated becomes higher than the rotation speed of the first fan motor 44 when regenerative electric power is not being generated.

Similarly, the control apparatus 60 may rotate the second fan motor 45 at a rotation speed in accordance with the temperature of the battery 42 when regenerative electric power is not being generated, or may rotate the second fan motor 45 at a fixed rotation speed when regenerative electric power is not being generated, provided that the control apparatus 60 controls the second fan motor 45 so that the rotation speed of the second fan motor 45 when regenerative electric power is generated becomes higher than the rotation speed of the second fan motor 45 when regenerative electric power is not being generated.

Additionally, the control apparatus 60 may operate the air conditioning apparatus 46 so as to keep the temperature of the driver's cabin 122 at a set temperature that has been preset when regenerative electric power is not being generated. In this case, the control apparatus 60 may lower the set temperature of the air conditioning apparatus 46 when regenerative electric power is generated, or may implement control not to stop the compressor regardless of the set temperature.

The first fan motor 44, the second fan motor 45 and the air conditioning apparatus 46 may be configured so as not to operate when regenerative electric power is not being generated.

### Second Embodiment

In the wet-type brake 14, decreases in the braking force due to heat generation (e.g., the occurrence of brake fade effects) are prevented by cooling with cooling oil. However, if the hauling vehicle 10 is made to go downslope for a long period of time, there is a possibility that the cooling of the wet-type brake 14 will not be able to keep up, thereby causing the braking force to decrease. In response thereto, the hauling vehicle 10 according to a second embodiment makes use of regenerative electric power to prevent lowered performance of the wet-type brake 14.

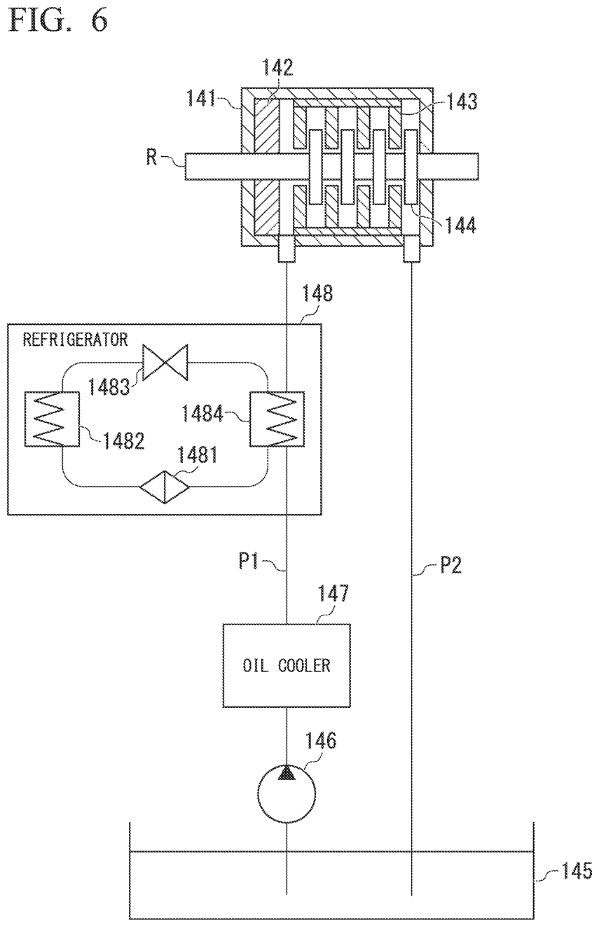

FIG. 6 is a schematic diagram illustrating the structure of a wet-type brake 14 according to the second embodiment. The wet-type brake 14 according to the second embodiment is provided with a refrigerator 148 on the first flow passage P1 in addition to the structure of the first embodiment.

The refrigerator 148 is provided with a compressor 1481, a condenser 1482, an expansion valve 1483, and an evaporator 1484. The compressor 1481 is driven by DC electric power flowing to the bus line B to compress a refrigerant. The condenser 1482 dissipates heat from the refrigerant by exchanging heat between a coolant and high-pressure refrigerant discharged from the compressor 1481. The expansion valve 1483 reduces the pressure of the refrigerant that has passed through the condenser 1482. The evaporator 1484 evaporates the refrigerant by exchanging heat between low-pressure refrigerant flowing from the expansion valve 1483 and cooling oil passing through the first flow passage P1. As a result thereof, the heat of the cooling oil passing through the first flow passage P1 can be dissipated. The refrigerator 148 is an example of a cooling apparatus for the wet-type brake 14.

When regenerative electric power is generated in the travel motor 47, the control apparatus 60 also outputs a drive instruction to the compressor 1481 (step S4 in FIG. 5) in addition to the first fan motor 44, the second fan motor 45, and the air conditioning apparatus 46. As a result thereof, the compressor 1481 is driven by the regenerative electric power flowing to the bus line B to drive the refrigerator 148. As a result thereof, the cooling oil supplied to the brake housing 141 is cooled, and the braking force of the wet-type brake 14 can be prevented from decreasing.

Thus, according to the hauling vehicle 10 of the second embodiment, the refrigerator 148 in the wet-type brake 14 can be operated by regenerative electric power, thereby absorbing regenerative electric power and further preventing decreases in the braking force of the wet-type brake 14. By preventing decreases in the braking force of the wet-type brake 14, the magnitude of the regenerative electric power generated by the travel motor 47 can be reduced. That is, the hauling vehicle 10 according to the second embodiment can greatly reduce the regenerative electric power to be absorbed by the retarder grid 48.

While the pump motor 43 according to the second embodiment operates regardless of whether or not there is regenerative electric power, the refrigerator 148 operates only when regenerative electric power is generated. That is, the combination of the pump motor 43 and the oil cooler 147 is a primary cooling apparatus, and the refrigerator 148 is an auxiliary cooling apparatus. As a result thereof, when the hauling vehicle 10 is not braking, the electric power consumed by the refrigerator 148 can be suppressed. Additionally, when braking the hauling vehicle 10, the braking force of the wet-type brake 14 can be increased by operating the refrigerator 148, and the regenerative electric power can be further absorbed.

### Third Embodiment

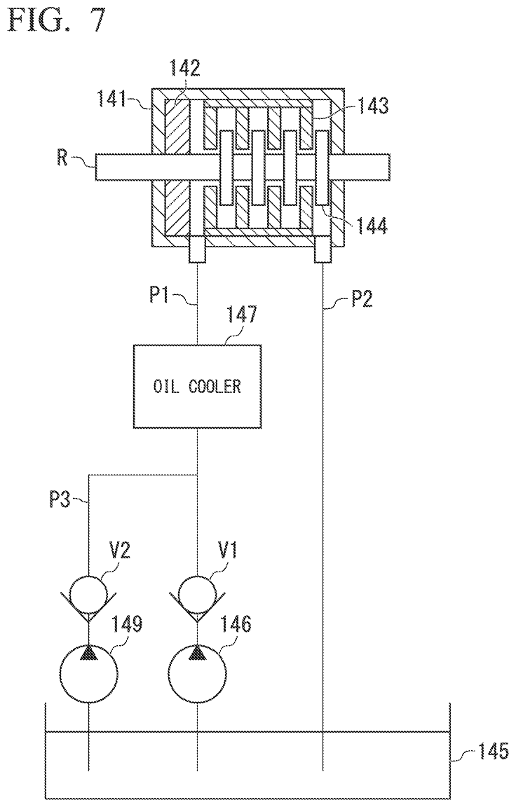

The hauling vehicle 10 according to a third embodiment increases the braking force of the wet-type brake 14 when braking by a configuration different from that in the second embodiment. FIG. 7 is a schematic diagram illustrating the structure of the wet-type brake 14 according to the third embodiment.

The wet-type brake 14 according to the third embodiment is provided with a third flow passage P3 that connects the cooling oil tank 145 with an intermediate portion of the first flow passage P1 between the cooling oil pump 146 and the oil cooler 147. The third flow passage P3 is provided with an auxiliary pump 149 and a check valve V2. The auxiliary pump 149 is driven when the hauling vehicle 10 brakes, and pumps the cooling oil held in the cooling oil tank 145. The check valve V2 allows cooling oil to flow from the auxiliary pump 149 towards the oil cooler 147, and blocks the flow of cooling oil from the oil cooler 147 towards the auxiliary pump 149.

The check valve V1 is provided on the first flow passage P1 between the cooling oil pump 146 and a portion connected to the third flow passage P3. The check valve V1 allows cooling oil to flow from the cooling oil pump 146 towards the oil cooler 147, and blocks the flow of cooling oil from the oil cooler 147 towards the cooling oil pump 146.

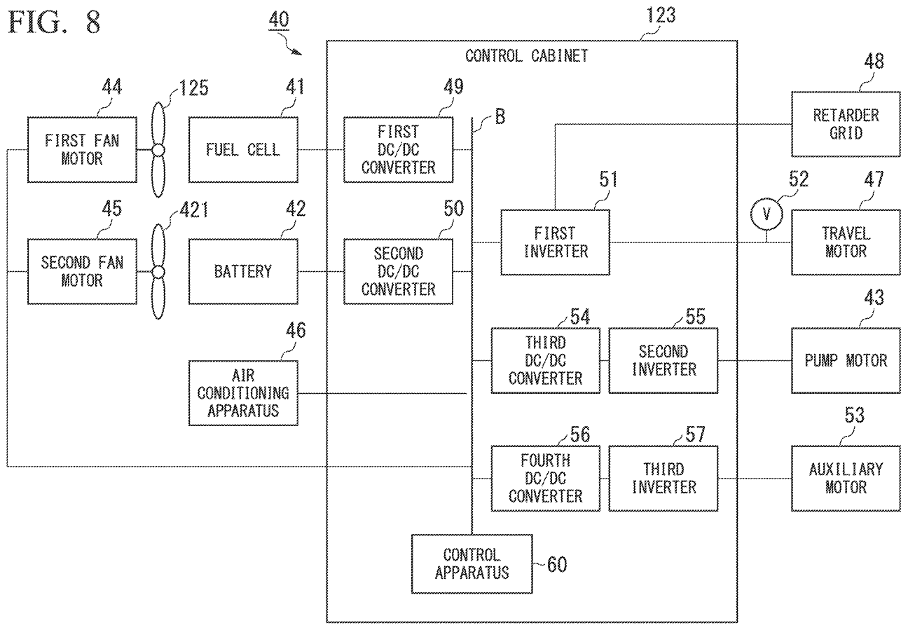

FIG. 8 is a schematic block diagram illustrating the structure of the electrical system 40 provided in the hauling vehicle 10 according to the third embodiment. The electrical system 40 according to the third embodiment is further provided with a fourth DC/DC converter 56, a third inverter 57, and an auxiliary motor 53 in addition to the structure of the first embodiment. The auxiliary motor 53 drives the auxiliary pump 149.

In the case in which regenerative electric power is being generated in the travel motor 47, the control apparatus 60 also outputs a drive instruction to the auxiliary motor 53 (step S4 in FIG. 5) in addition to the first fan motor 44, the second fan motor 45, and the air conditioning apparatus 46. As a result thereof, the auxiliary motor 53 is driven by the regenerative electric power flowing to the bus line B, and drives the auxiliary pump 149. By increasing the flow rate of the cooling oil supplied to the brake housing 141 by means of the auxiliary pump 149, the cooling performance of the wet-type brake 14 is improved. As a result thereof, the auxiliary pump 149 can prevent the braking force of the wet-type brake 14 from decreasing.

While the pump motor 43 according to the third embodiment operates regardless of whether or not there is regenerative electric power, the auxiliary motor 53 operates only when regenerative electric power is generated. That is, the combination of the pump motor 43 and the oil cooler 147 is a primary cooling apparatus, and the combination of the auxiliary motor 53 and the oil cooler 147 is an auxiliary cooling apparatus. As a result thereof, when the hauling vehicle 10 is not braking, the electric power consumed by the refrigerator 148 can be suppressed. Additionally, when the hauling vehicle 10 is braking, the braking force of the wet-type brake 14 can be increased by operating the auxiliary pump 149, and the regenerative electric power can be further absorbed.

### Other Embodiments

While embodiments have been explained in detail with reference to the drawings above, the specific structures are not limited to those mentioned above, and various design changes, etc. are possible. That is, in other embodiments, the order of the processes mentioned above may be appropriately changed. Additionally, some of the processes may be executed in parallel.

The control apparatus 60 according to the embodiments described above may be composed of a single computer, or the structure of the control apparatus 60 may be arranged to be divided between multiple computers, and the multiple computers may cooperate with each other to function as the control apparatus 60.

In the embodiments mentioned above, the fuel cell 41 and the battery 42 are cooled by fans. However, there is no limitation thereto. For example, the hauling vehicle 10 according to another embodiment may be provided with refrigerators as cooling apparatuses for the fuel cell 41 or the battery 42. In this case, the hauling vehicle 10 may constantly rotate the fan 125 and the fan 421 by means of the first fan motor 44 and the second fan motor 45, and may operate the refrigerators when regenerative electric power is generated. That is, the hauling vehicle 10 may be provided with refrigerators as auxiliary cooling apparatuses. As a result thereof, the fuel cell 41 and the battery 42 can be cooled by blowing air at ambient temperature when regenerative electric power is not being generated, and the fuel cell 41 and the battery 42 can be cooled by blowing air that has been cooled by the refrigerators when regenerative electric power is being generated.

In the embodiments described above, the fuel cell 41 and the battery 42 are air-cooled by fans. However, there is no limitation thereto. For example, the hauling vehicle 10 according to another embodiment may be water-cooled by providing a circulation pump, a circulatory flow passage, and a radiator as a cooling apparatus for the fuel cell 41 or the battery 42. In this case, the fuel cell 41 is provided with a circulatory flow passage for circulating a coolant. The circulatory flow passage is provided with a circulation pump for supplying the coolant and a radiator that dissipates heat from the coolant. The radiator cools the coolant in the radiator by blowing air from the fan 125 or the fan 421 rotated by the first fan motor 44 or the second fan motor 45. The coolant supplied by the circulation pump cools the fuel cell, while circulating through the circulatory flow passage, by receiving heat generated by a power generation reaction of the fuel cell and dissipating the heat in the radiator.

In this case, the hauling vehicle 10 may rotate the first fan motor 44 at a rotation speed in accordance with the temperature of the fuel cell 41 when regenerative electric power is not being generated, or may rotate the first fan motor 44 at a fixed rotation speed when regenerative electric power is not being generated, provided that the control apparatus 60 controls the first fan motor 44 so that the rotation speed of the first fan motor 44 when regenerative electric power is generated becomes higher than the rotation speed of the first fan motor 44 when regenerative electric power is not being generated.

Similarly, the control apparatus 60 may rotate the second fan motor 45 at a rotation speed in accordance with the temperature of the battery 42 when regenerative electric power is not being generated, or may rotate the second fan motor 45 at a fixed rotation speed when regenerative electric power is not being generated, provided that the control apparatus 60 controls the second fan motor 45 so that the rotation speed of the second fan motor 45 when regenerative electric power is generated becomes higher than the rotation speed of the second fan motor 45 when regenerative electric power is not being generated.

In the embodiments mentioned above, the hauling vehicle 10 is driven by electric power generated by the fuel cell 41 and by electric power stored in the battery 42. However, there is no limitation thereto. For example, the hauling vehicle 10 according to another embodiment may not be provided with a fuel cell 41. For example, the hauling vehicle 10 according to another embodiment may be provided with only the battery 42 as a drive source and may be driven only by power stored in the battery 42.

In the embodiments mentioned above, a hauling vehicle 10 was explained as an example of a work vehicle. However, there is no limitation thereto. For example, the work vehicle according to another embodiment may be another work vehicle such as a hydraulic shovel, a wheel loader, a motor grader, etc.

According to the embodiments above, the work vehicle can consume regenerative electric power.

1. A work vehicle comprising:
an electric motor;
a traveling body driven by the electric motor; and
a cooling apparatus driven by regenerative electric power from the electric motor generated by braking of the traveling body, and that cools equipment provided in the work vehicle.

2. The work vehicle according to claim 1, further comprising
a fuel cell that generates electric power by reacting hydrogen gas with atmospheric oxygen,
the electric motor being driven by electric power generated by the fuel cell; and
the cooling apparatus being driven by the regenerative electric power to cool the fuel cell.

3. The work vehicle according to claim 1, further comprising
a brake apparatus that brakes the traveling body by frictional force,
the cooling apparatus supplying the brake apparatus with a coolant for cooling the brake apparatus.

4. The work vehicle according to claim 3, wherein
the cooling apparatus includes
a refrigerant pump driven regardless of the regenerative electric power and that pumps the refrigerant; and
a refrigerator driven by the regenerative electric power when the regenerative electric power is being generated, and that cools the refrigerant.

5. The work vehicle according to claim 3, wherein
the cooling apparatus includes
a refrigerant pump driven regardless of the regenerative electric power and that pumps the refrigerant; and
an auxiliary pump driven by the regenerative electric power when the regenerative electric power is being generated, and that pumps the refrigerant.

6. The work vehicle according to claim 1 to wherein
the electric power consumed by the cooling apparatus when the regenerative electric power is being generated is greater than the electric power consumed by the cooling apparatus when the regenerative electric power is not being generated.

7. The work vehicle according to claim 1, wherein
the cooling apparatus includes
a main cooling apparatus driven regardless of the regenerative electric power; and
an auxiliary cooling apparatus driven by the regenerative electric power when the regenerative electric power is being generated.

8. The work vehicle according to claim 2, further comprising
a brake apparatus that brakes the traveling body by frictional force, the cooling apparatus supplying the brake apparatus with a coolant for cooling the brake apparatus.

9. The work vehicle according to claim 8, wherein
the cooling apparatus includes
a refrigerant pump driven regardless of the regenerative electric power and that pumps the refrigerant; and
a refrigerator driven by the regenerative electric power when the regenerative electric power is being generated, and that cools the refrigerant.

10. The work vehicle according to claim 9, wherein the cooling apparatus includes
a refrigerant pump driven regardless of the regenerative electric power and that pumps the refrigerant; and
an auxiliary pump driven by the regenerative electric power when the regenerative electric power is being generated, and that pumps the refrigerant.

11. The work vehicle according to claim 10, wherein
the electric power consumed by the cooling apparatus when the regenerative electric power is being generated is greater than the electric power consumed by the cooling apparatus when the regenerative electric power is not being generated.

12. The work vehicle according to claim 11, wherein
the cooling apparatus includes
a main cooling apparatus driven regardless of the regenerative electric power; and
an auxiliary cooling apparatus driven by the regenerative electric power when the regenerative electric power is being generated.
